(19) United States
(12) Patent Application Publication
(10) Pub. No.: US 2024/0000547 A1
(43) Pub. Date: Jan. 4, 2024

(54) TECHNIQUES FOR PRODUCING CUSTOMIZED BITE OPENING DEVICES VIA ADDITIVE FABRICATION AND RELATED SYSTEMS AND METHODS

(71) Applicant: LightForce Orthodontics, Inc., Burlington, MA (US)

(72) Inventors: Liam McKay, Brookline, MA (US); Dylan Winchell, Somerville, MA (US); Kelsey A. Fafara, Watertown, MA (US)

(73) Assignee: LightForce Orthodontics, Inc., Burlington, MA (US)

(21) Appl. No.: 18/340,428

(22) Filed: Jun. 23, 2023

Related U.S. Application Data
(60) Provisional application No. 63/357,089, filed on Jun. 30, 2022.

(51) Int. Cl. A61C 7/36; A61C 7/00; B33Y 10/00

(52) U.S. Cl. CPC A61C 7/36; A61C 7/002; B33Y 10/00

(57) ABSTRACT

Techniques are described for fabricating bite opening devices (BODs) that are customized to a patient's teeth and that can be accurately and strongly attached. The techniques include designing, and producing via additive fabrication, a bonding tray and a BOD that are contoured to match the patient's tooth anatomy. The BOD may be inserted into a cavity in the bonding tray, wherein the surface of the BOD and the bonding tray may match the tooth anatomy so that the tray and BOD can be guided to the proper location in the mouth, and so that the surface of the BOD matches the surface to which it will be attached. An adhesive may be applied to the surface of the BOD and cured to attach the BOD to the tooth. As a result, proper BOD placement is provided with a desired adhesion between the BOD and the tooth.

### RELATED APPLICATIONS

This application is a non-provisional of, and claims priority under 35 U.S.C. § 119(e) to, U.S. Provisional Application No. 63/357,089, titled “TECHNIQUES FOR PRODUCING CUSTOMIZED BITE OPENING DEVICES VIA ADDITIVE FABRICATION AND RELATED SYSTEMS AND METHODS,” filed Jun. 30, 2022, which is hereby incorporated by reference herein in its entirety.

### FIELD

The present application relates generally to the manufacturing of a bite opening device (BOD) sometimes also called a lingual bite block, a build-up, a button, a bite ramp, or a Bite Turbo.

### BACKGROUND

BODs are used in orthodontic practice to keep the mandible (lower jaw) from achieving maximum intercuspation (MIP) or in more familiar terms to “open the bite.” Orthodontic practitioners may utilize BODs during treatment to help avoid occlusal interferences with fixed appliances such as brackets and wires, but they may also be used for orthodontic tooth-moving purposes such as in correcting crossbite or intruding certain teeth or segments of teeth, or as an early treatment device to redirect dental development.

### SUMMARY

Some aspects relate to a computer-implemented method of generating three-dimensional (3D) models for additive fabrication of a bite opening device (BOD). The method includes obtaining, using at least one processor, a 3D model of one or more teeth of a patient, determining, using the at least one processor, a position of a BOD with respect to the one or more teeth and based at least in part on a desired occlusion of the one or more teeth, generating, using the at least one processor, a 3D model of a customized BOD at least in part by geometrically subtracting at least part of the 3D model of the one or more teeth from the 3D model of the BOD according to the determined position of the BOD, and generating instructions for an additive fabrication device that, when executed by the additive fabrication device, cause the additive fabrication device to fabricate the customized BOD.

Some aspects relate to a BOD manufactured using an additive manufacturing technique according to a method of generating 3D models for additive fabrication of a BOD. Some aspects relate to a non-transitory computer-readable media comprising instructions that, when executed by one or more processors on a computing device, are operable to cause the one or more processors to execute a method of generating 3D models for additive fabrication of a BOD. Some aspects relate to a system comprising a memory storing instructions, and a processor configured to execute the instructions to perform a method of generating 3D models for additive fabrication of a BOD.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1A depicts an illustrative anterior BOD, according to some embodiments;

FIG. 1B is a cross-sectional view of an illustrative anterior BOD, according to some embodiments;

FIGS. 2A-2D are perspective views depicting an illustrative process of using a customized bonding tray to attach customized BODs to a patient's teeth, according to some embodiments;

FIG. 3 is a perspective view of an illustrative BOD customized to match the geometry of molar cusps, according to some embodiments;

FIG. 4A is a perspective view of an illustrative customized BOD comprising retentive structures, according to some embodiments;

FIG. 4B is a cross-sectional view of a portion of the BOD of FIG. 4A, according to some embodiments;

FIG. 4C is a perspective view and a perspective cutoff view of an illustrative customized BOD comprising retentive structures, according to some embodiments;

FIG. 4D is a cross-sectional view of a portion of the BOD of FIG. 4C, according to some embodiments;

FIG. 4E is a perspective view of an illustrative BOD customized to match the geometry of molar cusps, according to some embodiments;

FIG. 4F is a perspective view of an illustrative BOD comprising a fracture groove, according to some embodiments;

FIG. 5 is a flowchart of a method of fabricating a customized BOD and customized bonding tray, according to some embodiments;

FIG. 6 is a flowchart of a method of attaching a customized BOD to a patient's teeth, according to some embodiments;

FIG. 7 is a block diagram of a system suitable for practicing aspects of the invention, according to some embodiments; and

FIG. 8 depicts a block diagram of an illustrative computing device which may be suitable for performing certain embodiments described herein.

### DETAILED DESCRIPTION

As described above, bite opening devices (BODs) may be used in orthodontic treatment to limit the relative motion of teeth of the upper and lower jaw. A BOD may be affixed to a tooth, such as on the interior (e.g., lingual or palatal) or exterior (e.g., buccal) side of a tooth, or on the cusp of a tooth. Due to its placement, the BOD is configured to limit the range of motion of the jaw by providing a surface for the teeth to contact. For instance, when wearing braces, a patient's teeth might be able to come into contact with a bracket, which could cause damage to the bracket and/or teeth (e.g., enamel). A BOD affixed to a tooth may inhibit the teeth from making contact with the bracket. As such, a BOD is often placed to manage the amount of occlusion between the teeth and avoid occlusal interferences. Additionally or alternatively, a BOD affixed to a tooth can be used for clinical reasons, such as to adjust a patient's bite and/or other aspects of the patient's anatomy. For example, BODs can be used to open and/or shift a patient's bite.

In some cases, BODs are conventionally formed by arranging a mold adjacent to the patient's teeth, where the mold includes a cavity filled with a curable material. The curable material is cured to form a solid BOD that is attached to the teeth. This approach may provide for accurate placement of the BOD, but both overfilling and underfilling of the cavity can lead to undesirable effects. For example, if the mold is overfilled, there is often flash or other excess material that requires clean up after bonding. Moreover, this excess material can cause the mold to attach to the teeth. Conversely, if the mold is underfilled, the BOD may not have the desired adhesion to the tooth.

In other cases, BODs are conventionally fabricated and placed by hand on the teeth. These prefabricated BODs may be attached to the teeth using a curable adhesive and shaped to a desired occlusion after attachment. This manual process can be time consuming and prone to errors, however, both of which are undesirable for the patient. In addition, proper adhesion may be challenging to achieve if the patient's tooth anatomy differs from the surface of the prefabricated BOD.

The inventors have recognized and appreciated techniques for fabricating BODs that are customized to a patient's tooth anatomy and that can be accurately and strongly attached to the teeth. The techniques include designing, and producing via additive fabrication, a bonding tray and a BOD that are contoured to match the patient's tooth anatomy. During the attachment procedure, a BOD may be inserted into a cavity in the bonding tray that is sized and shaped to match the BOD. Once inserted, the surface of the BOD and the bonding tray may match the tooth anatomy so that the tray and BOD can be guided to the proper location in the mouth, and so that the surface of the BOD matches the surface to which it will be attached. A dental adhesive may be applied to the surface of the BOD prior to insertion in the mouth and cured to attach the BOD to the tooth. As a result, proper BOD placement is provided with a desired adhesion between the BOD and the tooth.

According to some embodiments, an additively fabricated BOD may include a plurality of retentive structures at the intaglio surface of BOD (that is, the surface of the BOD that is bonded to the tooth's surface). The retentive structures may be partially recessed (or may produce a recessed region) within the intaglio surface so that some of the BOD is aligned at the intaglio surface, and some of the BOD is recessed toward the interior of the BOD, away from the intaglio surface. In some cases, the retentive structures may form one or more continuous spaces within the BOD (and in some cases, a single continuous space within the BOD). The retentive structures may increase the surface area by which an adhesive placed on the intaglio surface makes contact with the BOD, thereby increasing the bonding strength between the BOD and the tooth. In some cases, the retentive structures may be wider at the intaglio surface than at locations toward the center of the BOD. For example, the retentive structures may have the shape of an inverted truncated cone or truncated trapezoid, so that the structures are tapered away from the intaglio surface. Such structures may further increase the bonding strength between the BOD and the tooth.

According to some embodiments, the BOD and the bonding tray may be formed from different materials. It may be desirable for the tray to be comparatively compliant and flexible to be easily inserted and removed from the mouth, for instance, whereas the BOD may be comparatively more rigid and stronger to resist deformation and maintain proper bite position. In some embodiments, the BOD is harder than the bonding tray, and in some embodiments the BOD can be significantly harder than the boding tray (e.g., 1.5 times harder, two times harder, three times harder, etc.). For example, the BOD may have a high Shore D hardness (e.g., in the range of 70-90, 90-100, 97-100, etc.), whereas the bonding tray may have a lower Shore D hardness (e.g., in the range of 15-40). For example, a typical bracket used for braces, which can be formed from a ceramic, can have a Shore D hardness of around 97. The bracket may be harder (e.g., above 97, between 98 to 100, etc.). In some embodiments, the BOD may be additively fabricated from a biocompatible polymer, which may provide desirable mechanical properties as described above. In some embodiments, the BOD and the bonding tray may be additively fabricated from different biocompatible polymers.

Following below are more detailed descriptions of various concepts related to, and embodiments of, techniques for fabricating customized BODs. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

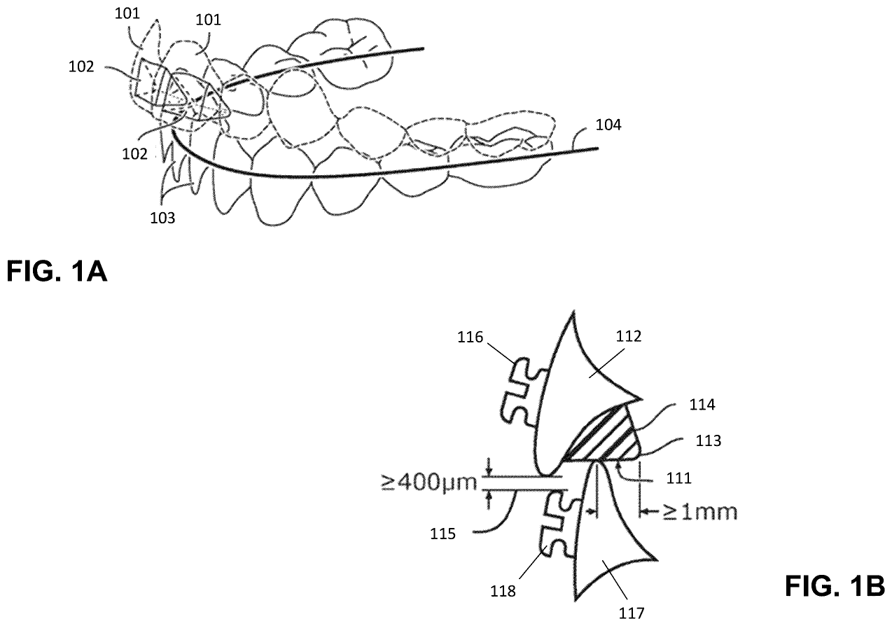

For purposes of illustration, FIG. 1A depicts an example of an anterior BOD, according to some embodiments. In the example of FIG. 1A, BODs 102 are attached to the palatal surface of the maxillary teeth 101, and are configured to inhibit motion of the mandibular teeth 103 beyond a desired occlusion. Also shown is an occlusal arch/plane 104. When a treating dentist determines that BODs are desired, the dentist may determine both the shape and the position of the BODs. The shape of the BODs may be different for an anterior BOD or a posterior BOD, depending on the tooth to which the BOD is to be bonded, and depending on the purpose of the BOD.

FIG. 1B is a cross-sectional view of an illustrative anterior BOD, according to some embodiments. As with the example of FIG. 1A, a BOD 114 is attached to an anterior tooth 112, although in FIG. 1B the tooth 112 also has a bracket 116 attached on the buccal surface. A lower tooth 117 also has a bracket 118 attached on its buccal surface. In the absence of the BOD 114, due to the arrangement of the teeth 112 and 117, upon closing of the jaw, the tooth 112 may impact the bracket 118. The BOD 114 is attached to the tooth 112 to inhibit this contact so that occlusal table 111 instead contacts the tooth 117. In addition, the BOD is shaped and positioned to produce a desired occlusion of the teeth 115, in this case a distance of 400 μm between the tooth 112 and the bracket 118. In general, this distance may be set to the dentist's chosen level based on the positioning of the teeth and whether appliances, such as brackets, are present. In the example of FIG. 1B, the BOD 114 has beveled corners 113 and has a support wall 114 that makes an angle of less than 90° with the occlusal table 111.

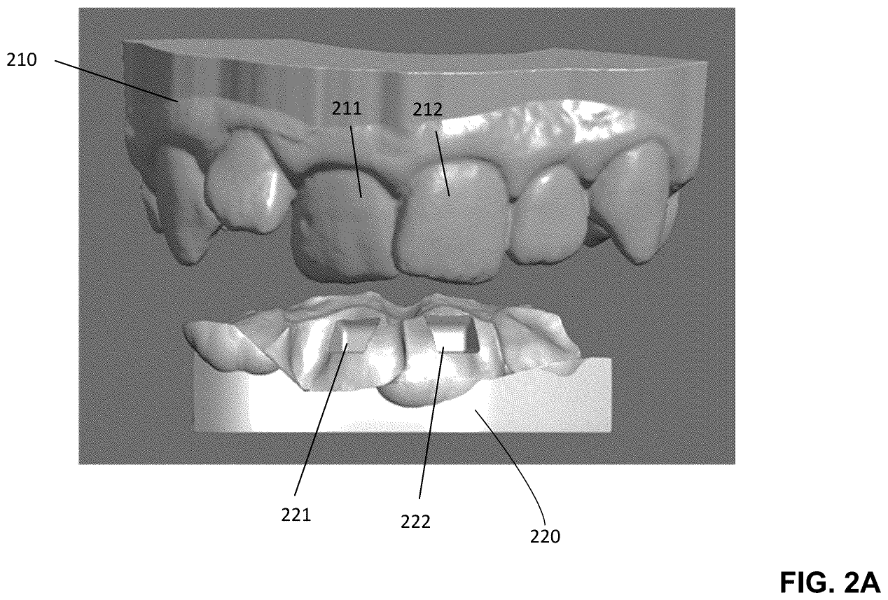

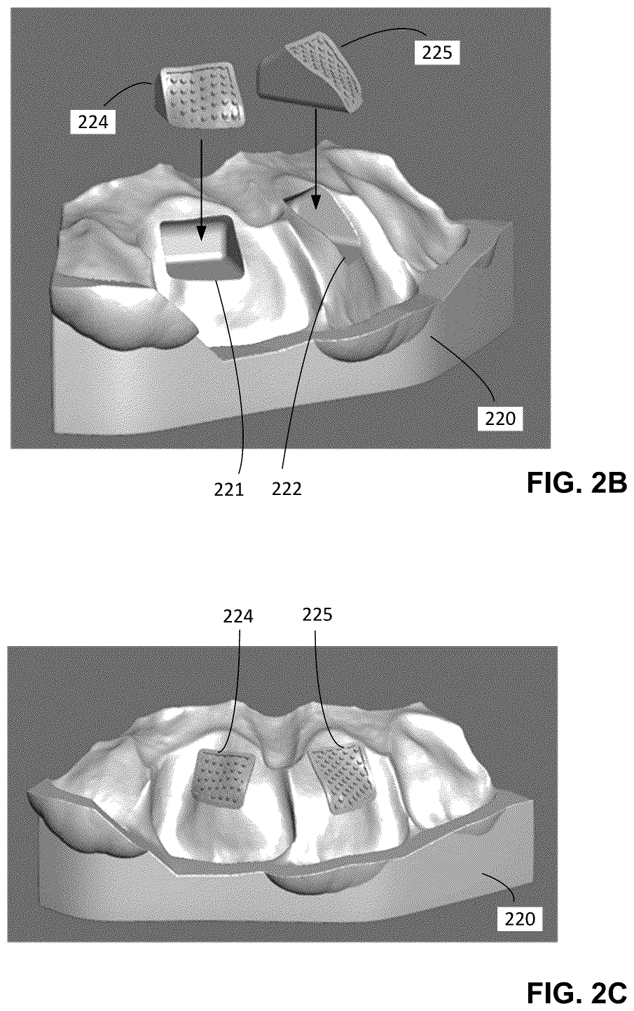

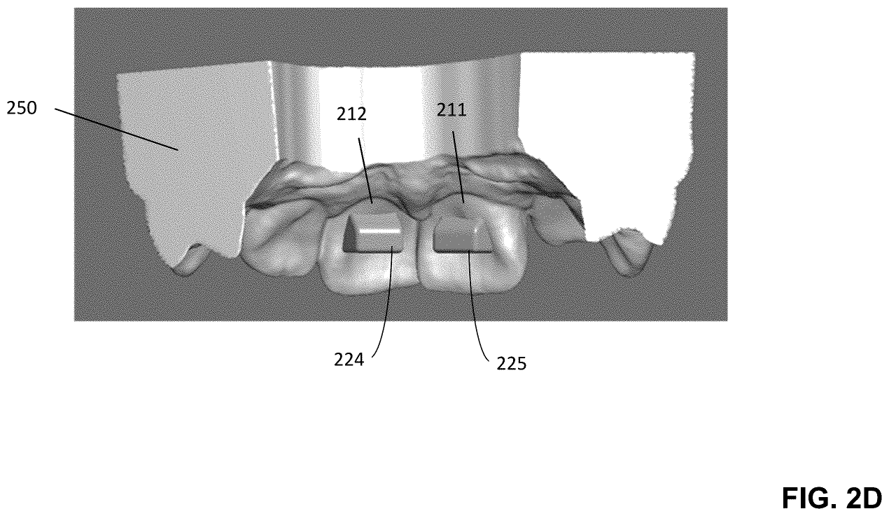

As described above, a process of bonding a BOD to a tooth may include fabricating a bonding tray and BODs through additive fabrication that are customized to a patient's tooth anatomy. The BODs may be attached to the patient's tooth by arranging the bonding tray in the patient's mouth so that it conforms to the tooth anatomy, and bonding the BODs to the teeth. FIGS. 2A-2D depict an illustrative example of this process, according to some embodiments.

FIG. 2A illustrates a 3D view of a patient's teeth 210 and a bonding tray 220. A 3D model of the patient's teeth can be obtained using a suitable scanner, and utilized to generate a 3D model of a customized bonding tray, as will be described further below. As may be noted in the example of FIG. 2A, the bonding tray 220 is shaped to match the palatal surfaces of the teeth 210, and also includes a portion that extends underneath the teeth and onto the buccal surface. This shape allows the bonding tray to be seated on the teeth in the desired position and orientation while limiting motion of the tray that might move the tray away from this position and/or orientation.

In the example of FIG. 2A, the bonding tray 220 includes two cavities 221 and 222, each of which are configured to hold a BOD that will be attached to the palatal side of the teeth 210. Specifically, the BODs in cavities 221 and 222 will be attached to the palatal side of the teeth 211 and 212, respectively. The shapes of the cavities 221 and 222 may be configured by performing geometrical operations on the 3D model of the bonding tray based on 3D models of the BODs and their intended positions relative to the teeth, as will be described further below.

FIG. 2B depicts a 3D view of the bonding tray 220 and BODs 224 and 225, which are shown for illustration as being inserted into the cavities 221 and 222, respectively. In the example of FIG. 2B, the BODs 224 and 225 have retentive structures configured to increase the bonding strength between the BOD and the tooth, as described further below. FIG. 2C depicts the combination of BODs and bonding tray after insertion of the BODs. As may be noted, the BODs have an intaglio surface that matches the surface contours of the bonding tray. As such, the BODs are configured to fit to the surface of the teeth to which they are attached by matching the surface shape of those teeth.

The BODs and the bonding tray may each be fabricated through additive fabrication. Further details of this process are described below. Once fabricated, the fabricated BODs may be inserted into the fabricated bonding tray, adhesive may be applied to the BODs and the bonding tray inserted into the patient's mouth. FIG. 2D depicts a 3D view of the patient's teeth 250 from the palatal side subsequent to bonding of the BODs 224 and 225 to the teeth and removal of the bonding tray. As shown, the BODs 224 and 225 protrude outward from the palatal surface of the teeth 211 and 212. It will be appreciated that the teeth shown in FIG. 2D are intended to represent the patient's actual teeth with fabricated BODs bonded to them, whereas the teeth shown in FIG. 2A are intended to represent a 3D model of the patient's teeth.

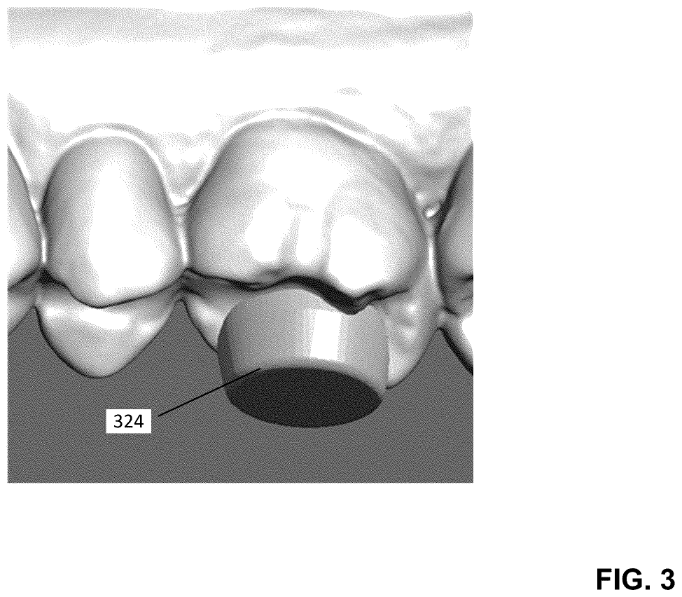

FIG. 3 is a perspective view of an illustrative BOD customized to match the geometry of molar cusps, according to some embodiments. In some cases, a BOD 324 may be configured to match the geometries of the cusps of a molar tooth to maximize the contact area between the BOD and the tooth. Conventionally, molar BODs are challenging to form and/or attach due to the complex geometry of those teeth. However, the techniques described herein may provide a way to fabricate and attach such BODs.

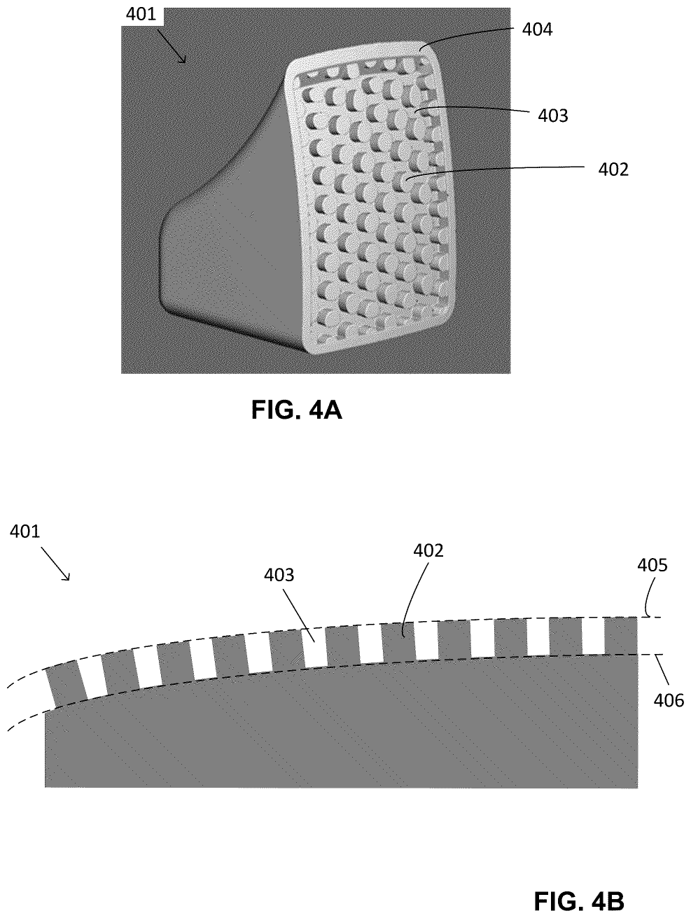

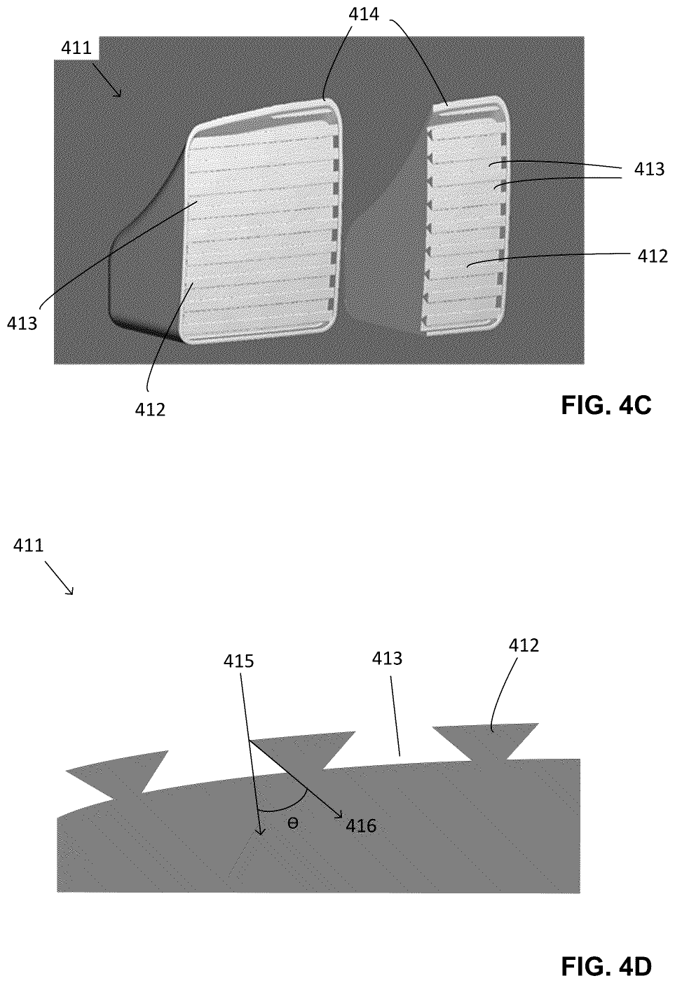

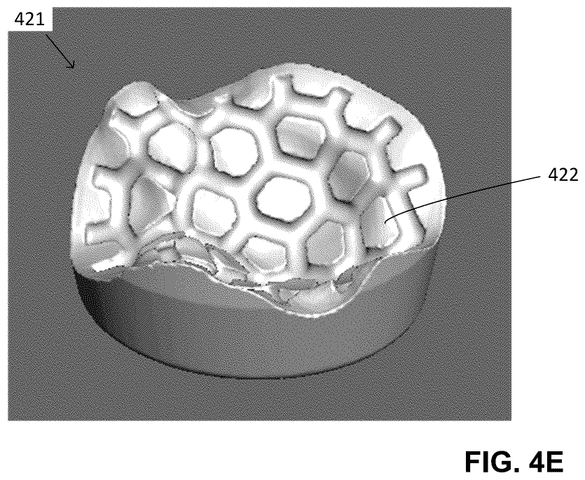

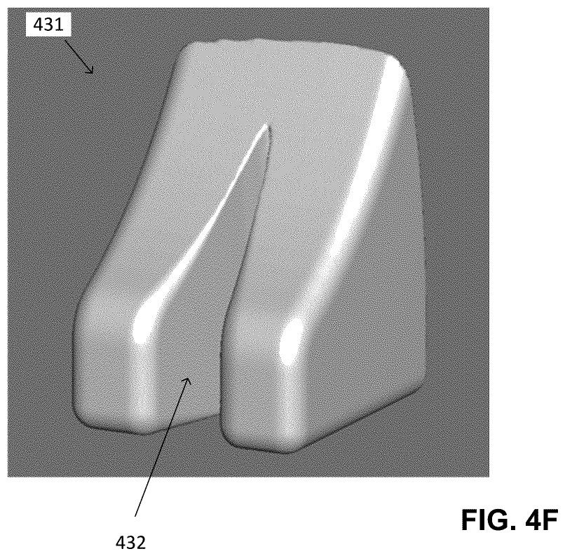

FIG. 4A is a perspective view, and FIG. 4B is a cross-sectional view, of an illustrative customized BOD comprising retentive structures, according to some embodiments. As described above, an additively fabricated BOD may include a plurality of retentive structures at the intaglio surface of BOD configured to increase the surface area by which an adhesive placed on the intaglio surface makes contact with the BOD. The illustrative BOD 401 includes such retentive structures 402.

The retentive structures 402 are formed at the intaglio surface 404 of the BOD 401. The intaglio surface 404 includes an outer perimeter section at the intaglio surface, and retentive structures 402 formed within the perimeter section. The retentive structures 402 include an upper surface at the intaglio surface (shown as a dashed line 405 in FIG. 4B), and connect to a lower surface 406 an offset distance below the intaglio surface. As shown, the retentive structures create a single continuous space 403 within the BOD. That is, any point between the intaglio surface 405 and the lower surface 406 outside of the retentive structures is connected with any other such point. This has a desired effect that adhesive placed onto this face of the BOD can flow into the space 403 between the retentive structures, and can make contact with both the lower surface 406 and the sides of the retentive structures 402. As a result, the total contact surface area between the adhesive and the BOD is much greater than the contact surface area of a BOD with a continuous flat intaglio surface. Moreover, the retentive structures may allow for the BOD to adhere to the tooth with a bond that is resistive to shear forces in more directions than a BOD bonded with a flat intaglio surface. For instance, the side walls of the retentive structures being adjacent to the adhesive may mean that shear forces on the BOD can be more readily resisted by the bond than a BOD attached via a flat intaglio surface.

In some cases, retentive structures of a BOD may be wider at the intaglio surface than at a lower surface of the bonding face arranged an offset distance below the intaglio surface. Such structures may further increase the strength of the bond between the tooth and the BOD due to a further increase in contact surface area, and/or may further increase the resistance of the bond between the BOD and the tooth to shear stresses. The retentive structures may have any suitable shape that taper to a narrower cross-section leading away from the intaglio surface. In some embodiments, the retentive structures may be trapezoidal (e.g., truncated trapezoids) or conical (e.g., truncated cones).

According to some embodiments, one way to quantify the extent to which the retentive structures have this shape is by referring to the “draft angle” of the side walls of the retentive structures. The draft angle may be defined, in at least some cases, as the angle between a direction normal to the intaglio surface and a surface direction of the side walls of the retentive structures. In the example of FIGS. 4A-4B, for instance, the retentive structures have a draft angle of zero, or around zero, since the side walls of the retentive structures are approximately normal to the intaglio surface 405. As described further below, the retentive structures of the example of FIGS. 4C-4D have a draft angle of greater than zero.

According to some embodiments, the draft angle may be more generally described as the angle between a direction that is perpendicular to a neutral plane, and a direction along the sidewall of the retentive structures within the BOD. The neutral plane may be oriented with respect to the intaglio surface, with respect to the surface of a tooth to which the BOD is to be bonded. The neutral plane may be flat or may be contoured to the shape of the intaglio surface or the tooth surface.

FIG. 4C depicts an illustrative BOD 411 in two views—on the left, a perspective view of the full BOD, and on the right, a perspective view of the same BOD shown in cross-section. A cross-sectional view of the BOD 411 is depicted in FIG. 4D. As shown in FIGS. 4C and 4D, the retentive structures 412 of the BOD 411 have the shape of truncated triangular prisms.

The retentive structures 412 are formed at the intaglio surface 414 of the BOD 411. The intaglio surface 414 includes an outer perimeter section at the intaglio surface, and parallel retentive structures 412 formed within the perimeter section. The retentive structures 412 include an upper surface at the intaglio surface and connect to a lower surface 416 at the bottom of the retentive structures. As shown, the retentive structures create a plurality of continuous spaces 413 within the BOD, with each continuous space extending from one side of the BOD to the other. As with the example of FIGS. 4A-4B, upon bonding to a tooth using an adhesive, the total contact surface area between the adhesive and the BOD 411 is much greater than the contact surface area of a BOD with a continuous flat intaglio surface. Moreover, the retentive structures 412 may allow for the BOD 411 to adhere to the tooth with a bond that is resistive to shear forces in more directions than a BOD bonded with a flat intaglio surface.

As shown in FIG. 4D, the retentive structures 412 have a cross-sectional shape that is wider at the intaglio surface than where the retentive structures meet the lower surface. As described above, one way to quantify such a shape is by referencing a draft angle θ, shown in FIG. 4D as the angle between a direction 415 normal to the intaglio surface and a direction 416 along the side wall of the retentive structure.

FIG. 4E is a perspective view of an illustrative BOD customized to match the geometry of molar cusps, according to some embodiments. While the example of FIGS. 4A-4D relate to BODs having a relatively flat, or slightly curved, surface, the BOD 421 is an example of a BOD configured for the cusps of a molar tooth, and has an intaglio surface contoured to fit around the cusps as shown. In addition, BOD 421 comprises retentive structures 422 that, as with the above examples of FIGS. 4A-4D, have an upper surface at the intaglio surface, and meet a lower surface an offset distance below the intaglio surface.

According to some embodiments, a BOD may be configured with one or more fracture grooves. Conventionally, BODs made from orthodontic composite adhesives are debonded from the tooth with a dental bur. The material of the BOD is ground off and removed from the tooth surface with the bur drill. Prefabricated non-custom metal or plastic bite turbos are debonded by rocking the device side to side with pliers until they peel off the tooth surface. As an alternative to these procedures, which can be uncomfortable for patients, a BOD as described herein may comprise one or more fracture grooves for ease of debonding. The fracture groove is shaped so that the stress is concentrated into particular regions of the BOD when pressure is applied to the BOD (e.g., by pliers on either side of the BOD), and thereby promotes a clean split of the turbo into two or more parts. During the split, the turbo peels off of the tooth surface for a clean and safe debond. According to some embodiments, a 3D model of a BOD may describe a BOD comprising a fracture groove, which may be adapted so as to fracture upon application of a force applied in at least one of a mesial-distal direction or an occlusal-gingival direction.

As one example, FIG. 4F is a perspective view of an illustrative BOD comprising a fracture groove, according to some embodiments. In the example of FIG. 4F, BOD 431 comprises a fracture groove 432 on the lingual side of the BOD. When force is applied in a mesial-distal direction, the device will fracture and allow for comparatively easier debonding from the tooth.

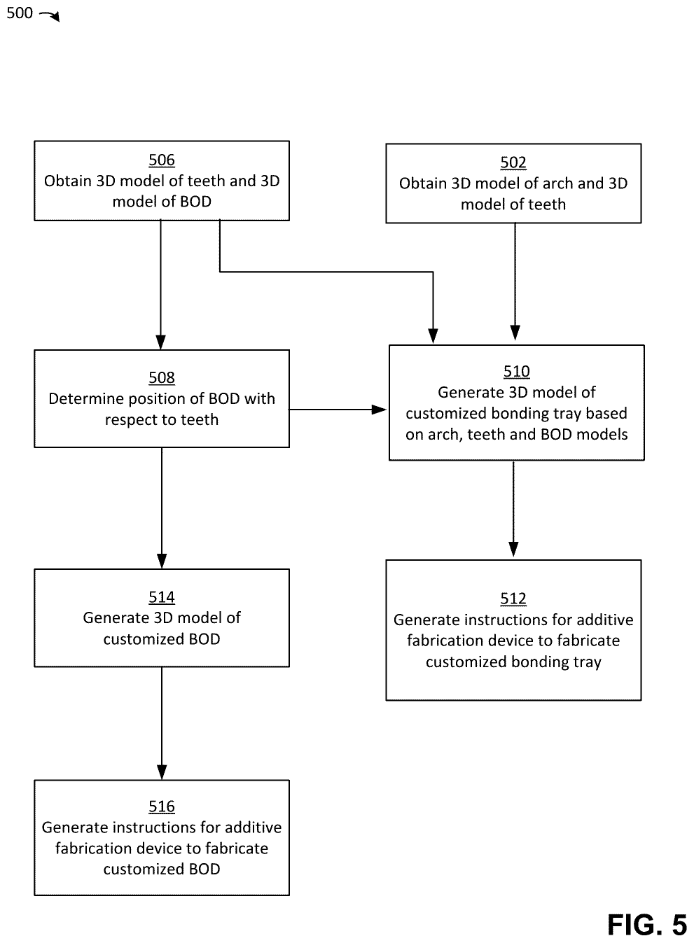

FIG. 5 is a flowchart of a method of fabricating a customized BOD and customized bonding tray, according to some embodiments. Method 500 may be performed by any suitable computing device or devices, examples of which are described below. Method 500 relates to a process of designing customized BODs and generating instructions for an additive fabrication device to fabricate the BODs (acts 506, 508, 514 and 516), and a process of designing a customized bonding tray and generating instructions for an additive fabrication device to fabricate the bonding tray (acts 502, 510 and 512). As such, method 500 may comprise performance of only some of these acts such as, for instance, performing acts 506, 508, 514 and 516 only to design customized BODs and generate instructions for an additive fabrication device to fabricate the BODs, without designing or generating instructions to fabricate a bonding tray.

In act 502, a 3D model of the arch of a patient is obtained. This model, as referred to herein, may include any non-teeth parts of the mouth, including any part of the arch, and optionally including any part of the gums. Moreover, a “3D model” (or simply “model”) as referred to herein may include any data describing a three-dimensional structure or structures, irrespective of file format or number of data files. According to some embodiments, the 3D model obtained in act 502 may be generated using a suitable optical scanner operated by a dental professional to generate a 3D model from images of the patient's mouth and teeth. In some embodiments, a scanned model may be processed to remove artifacts and/or otherwise preprocessed before use. Also in act 502, a 3D model of at least some of the patient's teeth is obtained. In some embodiments, a single model may encompass both the teeth and the arch (and optionally gums), so long as data describing both aspects of the patient's anatomy are obtained. In some embodiments when obtaining separate models, a common coordinate system, or other suitable data, is also obtained in act 502 to indicate how to arrange the arch and teeth in proper relative position and orientation to one another.

In act 506, a 3D model of at least some of the patient's teeth is obtained. According to some embodiments, the 3D model of at least some of the patient's teeth obtained in act 506 may be generated using a suitable optical scanner operated by a dental professional to generate a 3D model from images of the patient's teeth. In embodiments in which both acts 502 and 506 are performed, the same 3D model of the teeth may be obtained and then utilized in each case for subsequent steps of method 500.

Also in act 506, 3D models for one or more BODs are obtained. These BOD models may be pre-generated for particular dental needs and may be selected from a library of suitable BODs. For instance, BODs for molars, for anterior teeth, for buccal surfaces, for palatal surfaces, or for lingual surfaces, may be pre-generated and stored for later use. These 3D models of BODs may be generic to all patients in that they do not have bonding surfaces that are shaped to match any particular tooth surface. For instance, these models may be configured to be larger than the largest desirable BOD, with the expectation that part of the model will be removed in subsequent steps of method 500 described below.

In some embodiments, act 506 may comprise selection, by a user, of one or more 3D models of BODs from a graphical user interface (GUI). For example, the GUI may present a perspective view of a 3D model of at least some of the patient's teeth and allow a user to add a 3D model of a desired BOD from a list of available BOD models, to the view showing the model of the teeth.

In act 508, a user provides input to the computing device(s) performing method 500 indicating a relative positioning of the 3D model of the BOD(s) and the 3D model of the patient's teeth. Such user input may comprise a user moving and/or orienting a 3D model of a BOD within a GUI in multiple dimensions to arrange the BOD relative to a 3D model of at least part of the patient's teeth. In some embodiments in which act 506 comprises a user selecting a desired BOD model from a library of preconfigured models in a GUI, for instance, the user may drag a desired BOD model onto a workspace showing the teeth model and move and/or orient the BOD model relative to the teeth model to define a desired placement of the BOD. In some embodiments, the GUI may allow the user to adjust the relative position of the upper and lower teeth (e.g., by rotating the teeth around the jaw's hinge axis) to determine a desired position of a BOD model. For example, the teeth may be rotated to a position of maximum occlusion and a BOD model arranged to contact a desired tooth to prevent the teeth from further occlusion. It may be appreciated that at the end of act 508 in some embodiments, the one or more BOD models may be arranged partially within the teeth models, since the BOD models are to be modified to match the bonding surface of the teeth.

In act 510, a 3D model of a customized bonding tray is generated based on the 3D model of the arch, the teeth 3D models, and the BOD models. In some embodiments, act 510 includes subtracting the 3D models of the arch, teeth, and BOD models. The 3D models may be first arranged in a virtual space so that that have a relative position and orientation to one another that matches the patient's anatomy.

According to some embodiments, the 3D model of the bonding tray may be generated by obtaining a 3D model representing a generic bonding tray, aligning this model with the teeth, arch, and BODs, and performing a geometric subtraction (e.g., Boolean subtraction) of the teeth, arch and BODs from the 3D model of the generic bonding tray to produce a 3D model of a bonding tray that has regions carved out into which the teeth, BODs, and/or arch may fit. It should be appreciated that the 3D model of the bonding tray can be generated in one or more steps. For example, a single subtraction step and/or multiple subtraction steps can be performed for the teeth, arch, and BOD 3D models.

According to some embodiments, the 3D model of the bonding tray may be generated by determining an offset from desired surfaces of the teeth and arch to which the bonding tray will contact and forming this into a three-dimensional shell around those surfaces.

In some embodiments, subsequently some or all of the 3D model of the bonding tray may be scaled, or offset from the teeth or arch, to add a desired tolerance gap between the bonding tray and the teeth and/or arch. In some embodiments, an expected dimensional change during additive fabrication may be considered and used to scale the model larger or smaller. For instance, if the additive fabrication process is known to produce parts that shrink by a certain percentage, the model may be scaled larger by this percentage to offset the expected shrinkage. In some embodiments, both a tolerance gap and expected shrinkage may be taken into account when scaling the generated 3D model of the bonding tray.

In some embodiments, some or all of the 3D models of the customized bonding tray may be scaled or offset from the BOD model(s) to add a desired tolerance gap for the BODs to fit comfortably into the bonding tray after both are fabricated. As described above, expected dimensions of the additively fabricated BODs and bonding trays (which may have different expected shrinkages, for instance) may be considered when modifying the size of the generated customized bonding tray model.

In act 512, instructions are generated for an additive fabrication device that, when executed by the additive fabrication device, will fabricate the customized bonding tray according to the 3D model of the customized bonding tray generated in act 510. In some embodiments, the additive fabrication device may be configured to fabricate the customized bonding tray from a biocompatible polymer, such as a photopolymer resin. For instance, the additive fabrication device may be a stereolithographic or DLP device.

In general, it is desirable that the customized bonding tray is formed from a fairly compliant and flexible material. Ideally, the material must be rigid enough to hold the bracket or device bite turbo in place in the well/cavity, yet flexible enough to release easily from the device once the device is bonded to the tooth. In some embodiments, the additive fabrication device is configured to fabricate the customized bonding tray from a material having a Shore D hardness rating of greater than or equal to 10, 15, 20, 25, 30, or 35. In some embodiments, the additive fabrication device is configured to fabricate the customized bonding tray from a material having a Shore D hardness rating of less than or equal to 40, 35, 30, 25, 20, or 15. Any suitable combinations of the above-referenced ranges are also possible (e.g., the additive fabrication device is configured to fabricate the customized bonding tray from a material having a Shore D hardness rating of greater than or equal to 15 and less than or equal to 40).

According to some embodiments, the material from which the additive fabrication device is to fabricate the customized bonding tray may be indicated, at least in part, by the instructions generated in act 512.

In act 514, one or more 3D models of customized BODs are generated based on the one or more models of BODs arranged in act 508, and based on the model of the teeth and their position and orientation relative to the one or more BOD models. In some embodiments, the 3D models of the customized BODs may be generated by subtracting the 3D models of the teeth from the one or more BOD models obtained in act 506. For example, a Boolean subtraction operation may be performed on the one or more BOD models when they are arranged in desired locations relative to the teeth, to produce BOD models that have intaglio surfaces that match those of the teeth. In some embodiments, an expected dimensional change during additive fabrication may be considered and used to scale the customized BOD model(s) larger or smaller, as described above.

In some embodiments, act 514 comprises generating retentive structures in the customized BOD models, examples of which are described above. The generation of retentive structures in the customized BOD models need not be a separate step from generation of the intaglio surface of the models, as these operations may be part of a single process. According to some embodiments, generating retentive structures in the customized BOD models may comprise projecting and/or overlaying one or more geometric patterns onto the intaglio surface. These patterns may include lattices or arrays, planes passing through the intaglio surface, and/or preset lattice geometries. The features of a geometric pattern may be thickened to produce a negative model of the retentive structures, and then subtracted from a BOD model to produce the desired retentive structures in the BOD model. In some cases, the features may be modified in size and/or shape based on distance from the intaglio surface prior to subtracting the negative model from the BOD model, to produce retentive structures that are wider at the intaglio surface than at a lower surface, as described above. In some embodiments, generating retentive structures in the customized BOD models may comprise projecting and/or overlaying one or more geometric patterns onto the intaglio surface and performing an inward (negative) extrusion operation on the space defined by these patterns.

In act 516, instructions are generated for an additive fabrication device that, when executed by the additive fabrication device, will fabricate the one or more customized BODs according to the 3D model(s) of the customized BODs generated in act 510. In some embodiments, the additive fabrication device may be configured to fabricate customized BODs from a biocompatible polymer, such as a photopolymer resin. For instance, the additive fabrication device may be a stereolithographic or DLP device.

It is important that BODs are rigid enough to maintain the intended position of the bite through adequately resisting deforming, yet soft enough to provide patient comfort and without risking damage to tooth enamel. The desired hardness range of a BOD is therefore greater than a bonding tray, which should preferably be flexible and compliant as described above, yet smaller than the hardness of orthodontic appliances such as brackets, which must not creep or deform and as a result typically have a Shore D hardness of above 95, such as 97. In some embodiments, the additive fabrication device is configured to fabricate the customized BODs from a material having a Shore D hardness rating of greater than or equal to 60, 65, 70, 75, 80 or 85. In some embodiments, the additive fabrication device is configured to fabricate the customized BODs from a material having a Shore D hardness rating of less than or equal to 90, 85, 80, 75, 70, or 65. Any suitable combinations of the above-referenced ranges are also possible (e.g., the additive fabrication device is configured to fabricate the customized bonding tray from a material having a Shore D hardness rating of greater than or equal to 70 and less than or equal to 90).

According to some embodiments, the additive fabrication device may be configured to fabricate customized BODs from multiple different materials using a multi-material additive fabrication process. In some embodiments, the multiple different materials may comprise a ceramic coated with a polymer (wherein the polymer provides the desired hardness and the ceramic may be of a different, e.g., higher, hardness), or may comprise a metal coated with a softer metal.

According to some embodiments, the material from which the additive fabrication device is to fabricate the customized bonding tray may be indicated, at least in part, by the instructions generated in act 512.

In some embodiments, in method 500 the additive fabrication devices for which instructions are generated in acts 512 and 516 may be the same type of device (e.g., may both be stereolithographic or DLP devices). In some embodiments, in method 500 the additive fabrication devices for which instructions are generated in acts 512 and 516 may be configured to fabricate parts from different materials. For example, the additive fabrication device for which instructions are generated in act 512 may be configured to fabricate parts from one type of polymer, whereas the additive fabrication device for which instructions are generated in act 516 may be configured to fabricate parts from a different type of polymer.

According to some embodiments, as discussed herein, method 500 may be performed by separating act 510 into multiple acts. For example, the multiple acts can include first subtracting the arch and 3D models from a model of a generic boding tray to generate an initial bonding tray model, and then subtracting the BOD models from the initial bonding tray model to generate the 3D model of the customized boding tray.

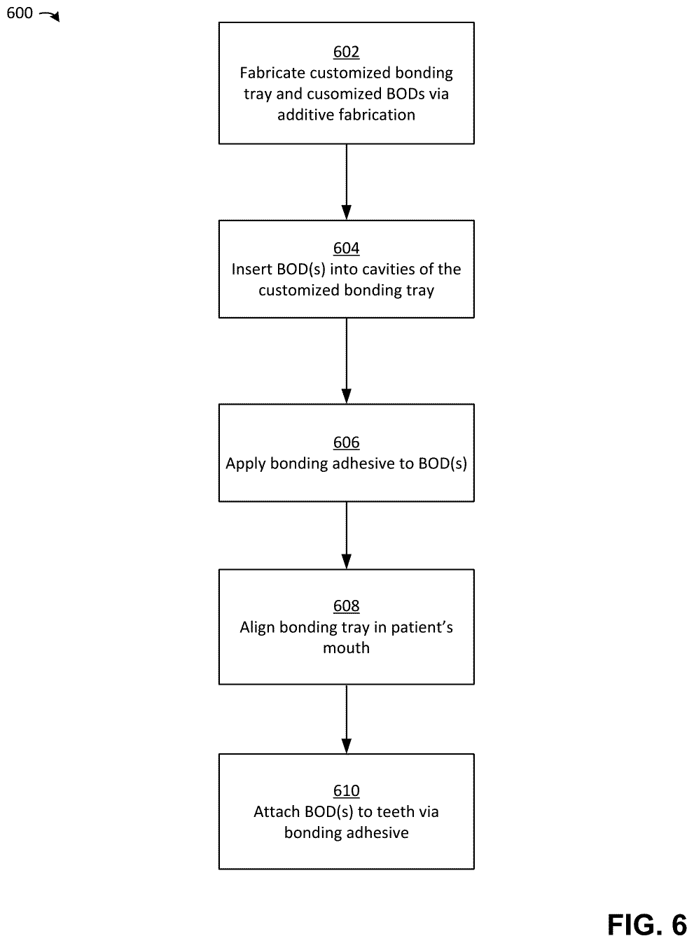

FIG. 6 is a flowchart of a method of attaching a customized BOD to a patient's teeth, according to some embodiments. Once customized BODs and a customized bonding tray have been fabricated according to the above-described techniques, they may be used to install the BODs onto a patient's teeth. Method 600, with the possible exception of act 602 as described below, may be performed by a dental professional.

In act 602, one or more customized BODs and a customized bonding tray are fabricated using one or more additive fabrication devices, as described above. In some embodiments, act 602 may be performed by one party and the fabricated parts supplied to a dental professional who uses them to perform the remainder of method 600. Alternatively, the dental professional may obtain instructions to fabricate the customized BODs and bonding tray (e.g., by performing method 500 or otherwise) and provide them to one or more additive fabrication devices to fabricate these parts. The one or more customized BODs and a customized bonding tray fabricated in act 602 may comprise any of the materials, and may have any of the material properties, described above in relation to acts 512 and 516.

In act 604, the one or more fabricated BODs are inserted into the fabricated bonding tray. In some cases, these fabricated parts may be supplied as a kit to a dental professional with instructions of how to insert the BODs into the bonding tray and affix the BODs to the teeth. In some cases, the BODs may be pre-inserted into the bonding tray when supplied to the dental professional.

In act 606, a suitable dental adhesive is applied by the dental professional to the fabricated BOD(s) in the fabricated bonding tray (or may alternatively be applied prior to their insertion in act 604). In act 608, the fabricated bonding tray is inserted into the patient's mouth and aligned based on the configured shape of the bonding tray and to properly align the BOD(s) with the teeth. In act 610, the adhesive is cured to affix the fabricated BOD(s) to the teeth and once properly affixed, the bonding tray may be removed.

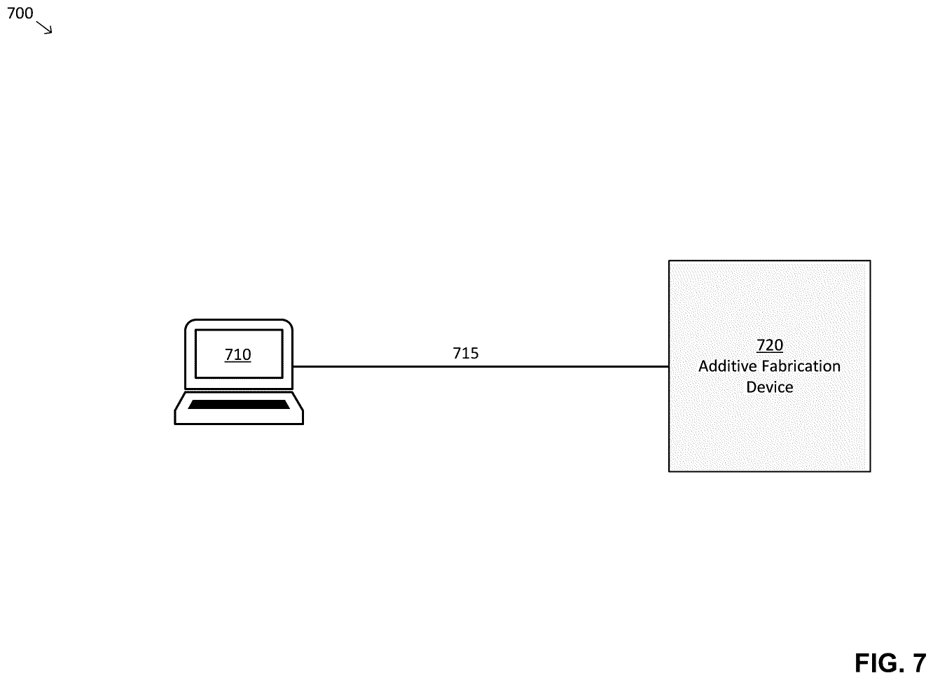

FIG. 7 is a block diagram of a system suitable for practicing aspects of the invention, according to some embodiments. System 700 illustrates a system suitable for generating instructions to perform additive fabrication by an additive fabrication device and subsequent operation of the additive fabrication device to fabricate a part. For instance, instructions to fabricate a customized BOD and/or customized bonding tray as described above may be generated by the system and provided to the additive fabrication device. Various parameters associated with materials from which to fabricate a BOD or bonding tray may be stored by computer system 710 and accessed when generating instructions for the additive fabrication device 720.

According to some embodiments, computer system 710 may execute software that generates instructions for fabricating a part using an additive fabrication device. Said instructions may then be provided to an additive fabrication device, such as additive fabrication device 720, via link 715, which may comprise any suitable wired and/or wireless communications connection. In some embodiments, a single housing holds the computing device 710 and additive fabrication device 720 such that the link 715 is an internal link connecting two modules within the housing of system 700.

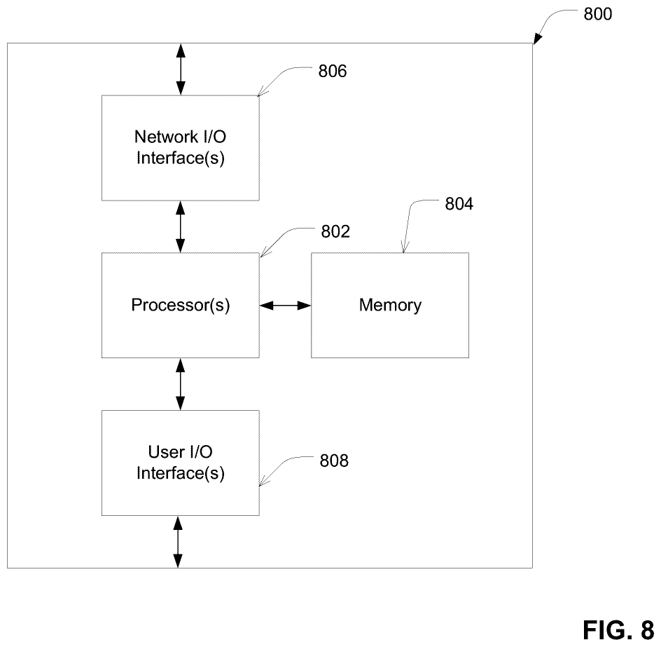

In some embodiments, systems and techniques described herein may be implemented using one or more computing devices. In particular, a controller may be operated to generate instructions that, when executed by an additive fabrication device, cause the additive fabrication device to fabricate a BOD or a bonding tray, as described above. Embodiments are not, however, limited to operating with any particular type of computing device. By way of further illustration, FIG. 8 is a block diagram of an illustrative computing device 800. Computing device 800 may include one or more processors 802 and one or more tangible, non-transitory computer-readable storage media (e.g., memory 804). Memory 804 may store, in a tangible non-transitory computer-recordable medium, computer program instructions that, when executed, implement any of the above-described functionality. Processor(s) 802 may be coupled to memory 804 and may execute such computer program instructions to cause the functionality to be realized and performed.

Computing device 800 may also include a network input/output (I/O) interface 806 via which the computing device may communicate with other computing devices (e.g., over a network), and may also include one or more user I/O interfaces 808, via which the computing device may provide output to and receive input from a user. The user I/O interfaces may include devices such as a keyboard, a mouse, a microphone, a display device (e.g., a monitor or touch screen), speakers, a camera, and/or various other types of I/O devices.

The above-described embodiments can be implemented in any of numerous ways. As an example, the embodiments may be implemented using hardware, software or a combination thereof. When implemented in software, the software code can be executed on any suitable processor (e.g., a microprocessor) or collection of processors, whether provided in a single computing device or distributed among multiple computing devices. It should be appreciated that any component or collection of components that perform the functions described above can be generically considered as one or more controllers that control the above-described functions. The one or more controllers can be implemented in numerous ways, such as with dedicated hardware, or with general purpose hardware (e.g., one or more processors) that is programmed using microcode or software to perform the functions recited above.

In some embodiments, a software-based application may be connected (e.g., via a wired or wireless connection) to one or more components of a computing device. In certain embodiments, for example, the computing device 800 may be controlled, at least in part, by a software-based application. In some cases, a user may operate a graphical user interface to perform one or more acts of method 500 through the software-based application. In some cases, the software-based application may store information (e.g., generated 3D models) generated based on user input.

In this respect, it should be appreciated that one implementation of the embodiments described herein comprises at least one computer-readable storage medium (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or other tangible, non-transitory computer-readable storage medium) encoded with a computer program (i.e., a plurality of executable instructions) that, when executed on one or more processors, performs the above-described functions of one or more embodiments. The computer-readable medium may be transportable such that the program stored thereon can be loaded onto any computing device to implement aspects of the techniques described herein. In addition, it should be appreciated that the reference to a computer program which, when executed, performs any of the above-described functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques described herein.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Various aspects of the present invention may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Various aspects are described in this disclosure, which include, but are not limited to, the following aspects:

1. A computer-implemented method of generating a three-dimensional (3D) model for additive fabrication of a bite opening device (BOD), the method comprising: obtaining, using at least one processor, a 3D model of one or more teeth of a patient; determining, using the at least one processor, a position of a BOD with respect to the one or more teeth and based at least in part on a desired occlusion of the one or more teeth; generating, using the at least one processor, a 3D model of a customized BOD at least in part by geometrically subtracting at least part of the 3D model of the one or more teeth from the 3D model of the BOD according to the determined position of the BOD; and generating instructions for an additive fabrication device that, when executed by the additive fabrication device, cause the additive fabrication device to fabricate the customized BOD.

2. The method of aspect 1, wherein generating the 3D model of the customized BOD further comprises generating a plurality of retentive structures at the intaglio surface of the customized BOD.

3. The method of aspect 2, wherein the retentive structures comprise a lower surface and a plurality of walls that rise from the lower surface to the intaglio surface.

4. The method of aspect 3, wherein the plurality of retentive structures are wider at the intaglio surface than at the lower surface.

5. The method of aspect 3, wherein the lower surface is offset a constant distance from the intaglio surface.

6. The method of any of aspects 2-5, wherein generating the plurality of retentive structures comprises projecting and/or overlaying a geometric pattern onto the intaglio surface of the customized BOD subsequent to geometrically subtracting the 3D model of the one or more teeth from the 3D model of the BOD.

7. The method of aspect 6, wherein generating the plurality of retentive structures further comprises subtracting the geometric pattern from the intaglio surface of the customized BOD.

8. The method of any of aspects 1-7, wherein determining the position of the BOD with respect to the one or more teeth is based at least in part on user input indicating a relative position in three-dimensional space between the BOD and the one or more teeth.

9. The method of any of aspects 1-8, wherein the instructions, when executed by the additive fabrication device, cause the additive fabrication device to fabricate the customized BOD from a material comprising at least one polymer.

10. The method of any of aspects 1-9, wherein the additive fabrication device is a first additive fabrication device, wherein the instructions are first instructions, and wherein the method further comprises: obtaining, using the at least one processor, a 3D model of at least part of an arch of the patient; generating, using the at least one processor, a 3D model of a custom bonding tray at least in part by geometrically subtracting at least part of the 3D model of the BOD from a 3D model of a generic bonding tray according to the determined position of the BOD; and generating second instructions for a second additive fabrication device that, when executed by the second additive fabrication device, cause the second additive fabrication device to fabricate the custom bonding tray.

11. The method of aspect 10, wherein the first additive fabrication device and the second additive fabrication device are the same additive fabrication device, and wherein the first instructions, when executed by the additive fabrication device, cause the additive fabrication device to fabricate the customized BOD from a first material, and wherein the second instructions, when executed by the additive fabrication device, cause the additive fabrication device to fabricate the custom bonding tray from a second material, different from the first material.

12. A method of aligning and attaching a bite opening device (BOD) to a patient, the method comprising: fabricating a bonding tray via additive fabrication, wherein the bonding tray is shaped according to one or more of a patient's teeth and comprises a cavity for insertion of a BOD; inserting a BOD into the cavity of the bonding tray leaving an exposed surface of the BOD, wherein the BOD comprises a polymer; applying a bonding adhesive to the exposed surface of the BOD; aligning the bonding tray against the patient's teeth; and attaching the BOD to one of the patient's teeth via the bonding adhesive.

13. The method of aspect 12, wherein the BOD is formed from a first polymer and wherein the bonding tray is formed from a second polymer, different from the first polymer.

14. The method of aspect 13, wherein the first polymer has a Shore D hardness of greater than 60 and less than 90, and wherein the second polymer has a Shore D hardness of less than 40.

15. The method of any of aspects 12-14, wherein the BOD comprises a ceramic or metal and wherein the polymer is arranged at the surface of the BOD, surrounding at least in part the ceramic or metal.

16. The method of any of aspects 12-14, wherein the BOD comprises a plurality of retentive structures at the intaglio surface of the BOD.

17. The method of aspect 16, wherein the retentive structures comprise a lower surface and a plurality of walls that rise from the lower surface to the intaglio surface.

18. The method of aspect 17, wherein the plurality of retentive structures are wider at the intaglio surface than at the lower surface.

19. The method of aspect 17, wherein the lower surface is offset a constant distance from the intaglio surface.

20. The method of any of aspects 12-19, wherein attaching the BOD to one of the patient's teeth via the bonding adhesive comprises curing the bonding adhesive.

21. A BOD manufactured using an additive manufacturing technique according to any of aspects 1-11.

22. A non-transitory computer-readable media comprising instructions that, when executed by one or more processors on a computing device, are operable to cause the one or more processors to execute the method of any of aspects 1-11.

23. A system comprising a memory storing instructions, and a processor configured to execute the instructions to perform the method of any of aspects 1-11.

1. A computer-implemented method of generating a three-dimensional (3D) model for additive fabrication of a bite opening device (BOD), the method comprising:
obtaining, using at least one processor, a 3D model of one or more teeth of a patient;
determining, using the at least one processor, a position of a BOD with respect to the one or more teeth and based at least in part on a desired occlusion of the one or more teeth;
generating, using the at least one processor, a 3D model of a customized BOD at least in part by geometrically subtracting at least part of the 3D model of the one or more teeth from the 3D model of the BOD according to the determined position of the BOD; and
generating instructions for an additive fabrication device that, when executed by the additive fabrication device, cause the additive fabrication device to fabricate the customized BOD.

2. The method of claim 1, wherein generating the 3D model of the customized BOD further comprises generating a plurality of retentive structures at the intaglio surface of the customized BOD.

3. The method of claim 2, wherein the retentive structures comprise a lower surface and a plurality of walls that rise from the lower surface to the intaglio surface.

4. The method of claim 3, wherein the plurality of retentive structures are wider at the intaglio surface than at the lower surface.

5. The method of claim 3, wherein the lower surface is offset a constant distance from the intaglio surface.

6. The method of claim 2, wherein generating the plurality of retentive structures comprises projecting and/or overlaying a geometric pattern onto the intaglio surface of the customized BOD subsequent to geometrically subtracting the 3D model of the one or more teeth from the 3D model of the BOD.

7. The method of claim 6, wherein generating the plurality of retentive structures further comprises subtracting the geometric pattern from the intaglio surface of the customized BOD.

8. The method of claim 1, wherein determining the position of the BOD with respect to the one or more teeth is based at least in part on user input indicating a relative position in three-dimensional space between the BOD and the one or more teeth.

9. The method of claim 1, wherein the instructions, when executed by the additive fabrication device, cause the additive fabrication device to fabricate the customized BOD from a material comprising at least one polymer.

10. The method of claim 1, wherein the additive fabrication device is a first additive fabrication device, wherein the instructions are first instructions, and wherein the method further comprises:
obtaining, using the at least one processor, a 3D model of at least part of an arch of the patient;
generating, using the at least one processor, a 3D model of a custom bonding tray at least in part by geometrically subtracting at least part of the 3D model of the BOD from a 3D model of a generic bonding tray according to the determined position of the BOD; and
generating second instructions for a second additive fabrication device that, when executed by the second additive fabrication device, cause the second additive fabrication device to fabricate the custom bonding tray.

11. The method of claim 10, wherein the first additive fabrication device and the second additive fabrication device are the same additive fabrication device, and wherein the first instructions, when executed by the additive fabrication device, cause the additive fabrication device to fabricate the customized BOD from a first material, and wherein the second instructions, when executed by the additive fabrication device, cause the additive fabrication device to fabricate the custom bonding tray from a second material, different from the first material.

12. A method of aligning and attaching a bite opening device (BOD) to a patient, the method comprising:
fabricating a bonding tray via additive fabrication, wherein the bonding tray is shaped according to one or more of a patient's teeth and comprises a cavity for insertion of a BOD;
inserting a BOD into the cavity of the bonding tray leaving an exposed surface of the BOD, wherein the BOD comprises a polymer;
applying a bonding adhesive to the exposed surface of the BOD;
aligning the bonding tray against the patient's teeth; and
attaching the BOD to one of the patient's teeth via the bonding adhesive.

13. The method of claim 12, wherein the BOD is formed from a first polymer and wherein the bonding tray is formed from a second polymer, different from the first polymer.

14. The method of claim 13, wherein the first polymer has a Shore D hardness of greater than 60 and less than 90, and wherein the second polymer has a Shore D hardness of less than 40.

15. The method of claim 12, wherein the BOD comprises a ceramic or metal and wherein the polymer is arranged at the surface of the BOD, surrounding at least in part the ceramic or metal.

16. The method of claim 12, wherein the BOD comprises a plurality of retentive structures at the intaglio surface of the BOD.

17. The method of claim 16, wherein the retentive structures comprise a lower surface and a plurality of walls that rise from the lower surface to the intaglio surface.

18. The method of claim 17, wherein:
the plurality of retentive structures are wider at the intaglio surface than at the lower surface; and
the lower surface is offset a constant distance from the intaglio surface.

19. The method of claim 12, wherein attaching the BOD to one of the patient's teeth via the bonding adhesive comprises curing the bonding adhesive.

20. A non-transitory computer-readable media comprising instructions that, when executed by one or more processors on a computing device, are operable to cause the one or more processors to generate a three-dimensional (3D) model for additive fabrication of a bite opening device (BOD), comprising:
obtaining, using at least one processor, a 3D model of one or more teeth of a patient;
determining, using the at least one processor, a position of a BOD with respect to the one or more teeth and based at least in part on a desired occlusion of the one or more teeth;
generating, using the at least one processor, a 3D model of a customized BOD at least in part by geometrically subtracting at least part of the 3D model of the one or more teeth from the 3D model of the BOD according to the determined position of the BOD; and generating instructions for an additive fabrication device that, when executed by the additive fabrication device, cause the additive fabrication device to fabricate the customized BOD.
